(19) United States
(12) Patent Application Publication
(10) Pub. No.: US 2008/0256087 A1
(43) Pub. Date: Oct. 16, 2008

(54) APPARATUSES AND METHODS FOR MANAGING CONTENT STORED IN DEVICES

(75) Inventors: Jarno Piironen, Espoo (FI); Kimmo Aalto, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/103,975

(22) Filed: Apr. 16, 2008

Related U.S. Application Data
(60) Provisional application No. 60/912,117, filed on Apr. 16, 2007.

(51) Int. Cl. G06F 17/30

(52) U.S. Cl. 707/10; 707/E17.032

(57) ABSTRACT

Apparatuses, methods, and computer program products for managing content are provided. The apparatus includes a processor that can communicate with a number of devices, identify content files stored by the devices, and provide a visible indicia of each device in which each content file is stored. The processor may also detect devices configured to store various types of content files and may receive user input selecting a particular content file for downloading, such as from a content provider's website. A list of the downloaded content files, along with information regarding each file, the devices capable of storing each file, and the devices actually used to store each file, may be displayed to the user. In this way, the user may be able to see a list of the various content files that have been downloaded as well as a visible indicia of where each file is stored.

### CROSS-REFERENCE TO RELATED APPLICATIONS

This application claims the benefit of U.S. Provisional Application No. 60/912,117 entitled “Apparatuses and Methods for Managing Content Stored in Devices” filed Apr. 16, 2007, the contents of which are incorporated herein by reference.

### TECHNOLOGICAL FIELD

Embodiments of the present invention relate generally to content management and storage technology and, more particularly, to managing content stored in one or more devices.

### BACKGROUND

As technology advances, the accessibility of data continues to grow. People are able to find more data on private and public networks as a result of continually improving search engines. In addition, data transmission rates continue to increase, allowing people to download content from remote servers faster and more efficiently, and, likewise, storage capacities on devices such as personal computers are increasing.

As a result, people are finding it easier to download and store large quantities of content on devices such as personal computers and mobile terminals. However, the increase in stored content files has also resulted in problems when it comes to personal management of stored content. For example, a user may enjoy downloading video content files, such as movies and video clips, from a content source and saving the files to multiple devices. The user may, for instance, save some files to his mobile phone, other files to his personal computer, and still other files to both devices.

With large numbers of files saved on multiple devices, it may be difficult to remember which file is stored in which device. The user may have to access the computer to see which files are stored in the computer and then access the mobile phone or other device to see which files are stored there. As a result, the user may decide it is simpler and less frustrating to simply download the sought content again as opposed to spending time looking for the content, which adds to network traffic and ends up consuming unnecessary storage space in the user's devices.

Thus, there is a need for an apparatus that can more effectively manage and keep track of multiple content files being stored on one or more device such that a user may be able to locate a content file by reference to one location, regardless of where the content files are stored.

### BRIEF SUMMARY

Apparatuses, methods, and computer program products are therefore provided for managing content that is downloaded from a content source and stored on one or more devices, such as a mobile terminal or computer. A representation of devices that are configured to store the content files to be downloaded may be indicated, as well as the devices actually storing the content, to allow a user to manage a number of content files that may be stored on one or more device.

In one exemplary embodiment, an apparatus for managing content is provided. The apparatus comprises a processor configured to communicate with a number of devices, identify at least one content file stored by one or more of the devices, and provide a visible indicia of each device in which each content file is stored. The apparatus may also include a display configured to communicate with the processor and to present the indicia of each device in which each content file is stored.

In some cases, the processor may also be configured to receive a selection of a particular content file stored in a content source from a user, identify at least one device configured to store the selected content file, and store the selected content file in at least one of the identified devices. The apparatus may include a user interface configured to communicate with the processor and to receive input from the user designating at least one aspect of content management, such as a particular content file to be downloaded from the content source and/or one or more of the identified devices in which to store the particular content file. The processor may, in some cases, be configured to determine the identified device in which to store the selected content file according to a methodology, for example, based on a type of content file, an amount of memory available in the device, a type of the device, and/or a user preference.

The processor may be configured to convert the selected content file from a first format as received from the content source to a second format that is compatible with each device in which the selected content file is stored. The processor may also be configured to receive a content management software application from a service provider prior to receiving the selected content file from the content source, for example, by accessing the selected content file from the content source via a custom Uniform Resource Locator protocol identifier, such as “nvd.” In some cases, the processor may be configured to provide an indication of at least one characteristic of each content file, such as a name, a length, a size, a date of downloading, and/or a download status of the content file.

In other exemplary embodiments, a method and computer program product for managing content are provided. The method and computer program product communicate with a number of devices, identify at least one content file stored by one or more of the devices, and provide a visible indicia of each device in which each content file is stored. In some cases, a selection of a particular content file stored in a content source may be received from a user. One or more devices configured to store the selected content file may be identified, and the selected content file may be stored in one or more of the identified devices.

In some cases, a designation of at least one of the identified devices in which to store the selected content file may be received from a user. Furthermore, at least one of the identified devices in which to store the selected content file may be determined according to a methodology that considers a factor such as the type of content file, an amount of memory available in the device, a type of the device, and/or a user preference.

The selected content file may be converted from a first format as received from the content source to a second format that is compatible with each device in which the selected content file is stored. Also, a content management software application may be received from a service provider prior to receiving the selected content file from the content source by accessing the selected content file from the content source via a custom Uniform Resource Locator protocol identifier. In some cases, an indication of at least one characteristic of each content file, such as a name, a length, a size, a date of downloading, and/or a download status of the content file, may be provided.

In another exemplary embodiment, an apparatus for managing content is provided that includes means for communicating with a number of devices, means for identifying at least one content file stored by at least one of the devices, and means for providing a visible indicia of each device in which each content file is stored. The apparatus may further include means for receiving a selection of a particular content file stored in a content source from a user, means for identifying at least one device configured to store the selected content file, and means for storing the selected content file in at least one of the identified devices.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic representation of a system according to an exemplary embodiment of the present invention;

FIG. 4 is a schematic block diagram of an apparatus according to an exemplary embodiment of the present invention;

FIG. 5 is a schematic representation of a computer in communication with a content provider's server and a service provider's server according to an exemplary embodiment of the present invention;

FIG. 6 is a screen generated by an apparatus according to an exemplary embodiment of the present invention;

FIG. 7 is a screen generated by an apparatus according to an exemplary embodiment of the present invention;

FIG. 8 is a screen generated by an apparatus according to an exemplary embodiment of the present invention;

FIG. 9 is a screen generated by an apparatus according to an exemplary embodiment of the present invention;

FIG. 10 illustrates a javascript for a content file link according to an exemplary embodiment of the present invention;

FIG. 11 illustrates a flowchart according to an exemplary embodiment for managing content;

FIG. 12 illustrates a flowchart according to an exemplary embodiment for managing content; and

FIG. 13 illustrates a flowchart according to an exemplary embodiment for managing content.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

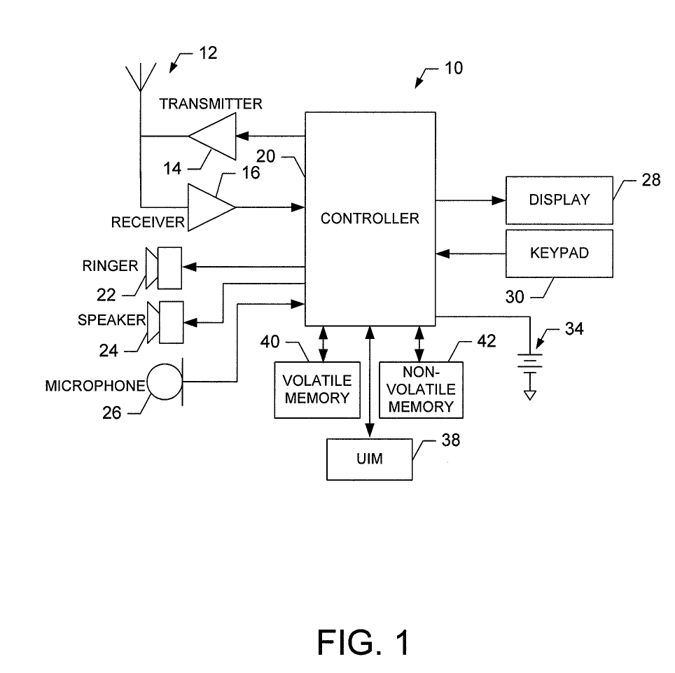

FIG. 1 illustrates a block diagram of a mobile terminal 10 that would benefit from embodiments of the present invention. It should be understood, however, that a mobile terminal as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, MP3 or other music players, cameras, laptop computers and other types of voice and text communications systems, can readily employ the present invention.

In addition, while several embodiments of the present invention will benefit a mobile terminal 10 as described below, embodiments of the present invention may also benefit and be practiced by other types of devices, i.e., fixed terminals. Moreover, the system, apparatus, and method of embodiments of the present invention will be primarily described in conjunction with mobile communications applications. It should be understood, however, that embodiments of the present invention can be utilized in conjunction with a variety of other applications, both in the mobile communications industries and outside of the mobile communications industries. Accordingly, embodiments of the present invention should not be construed as being limited to applications in the mobile communications industry.

In one embodiment, however, the device that stores the content files is a mobile terminal 10. Although the mobile terminal may be embodied in different manners, the mobile terminal 10 of one embodiment includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 of this embodiment also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

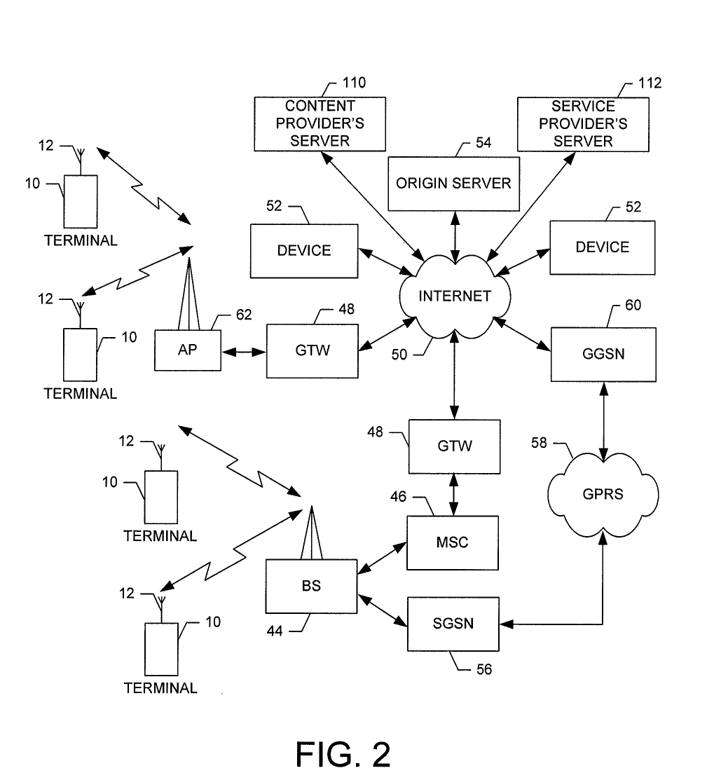

Referring now to FIG. 2, an illustration of one type of system that would benefit from and otherwise support embodiments of the present invention is provided. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a device 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a device 52 and/or origin server 54 may be coupled to the mobile terminal 10 via the Internet 50, SGSN 56 and GGSN 60. In this regard, devices such as the device 52 and/or origin server 54 may communicate with the mobile terminal 10 across the SGSN 56, GPRS core network 58 and the GGSN 60. By directly or indirectly connecting mobile terminals 10 and the other devices (e.g., device 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the device 52, the origin server 54, and/or any of a number of other devices, to the Internet 50, the mobile terminals 10 can communicate with one another, the device, etc., to thereby carry out various functions of the mobile terminals 10, such as to transmit data, content or the like to, and/or receive content, data or the like from, the device 52. Furthermore, the mobile terminals 10 and the devices 52 can communicate with and receive content from servers such as a content provider's server 110 and a service provider's server 112. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to devices 52 across the Internet 50, the mobile terminal 10 and device 52 may be coupled to one another and communicate in accordance with, for example, RF, BT, IrDA or any of a number of different wireline or wireless communication techniques, including LAN, WLAN, WiMAX and/or UWB techniques. One or more of the devices 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the devices 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

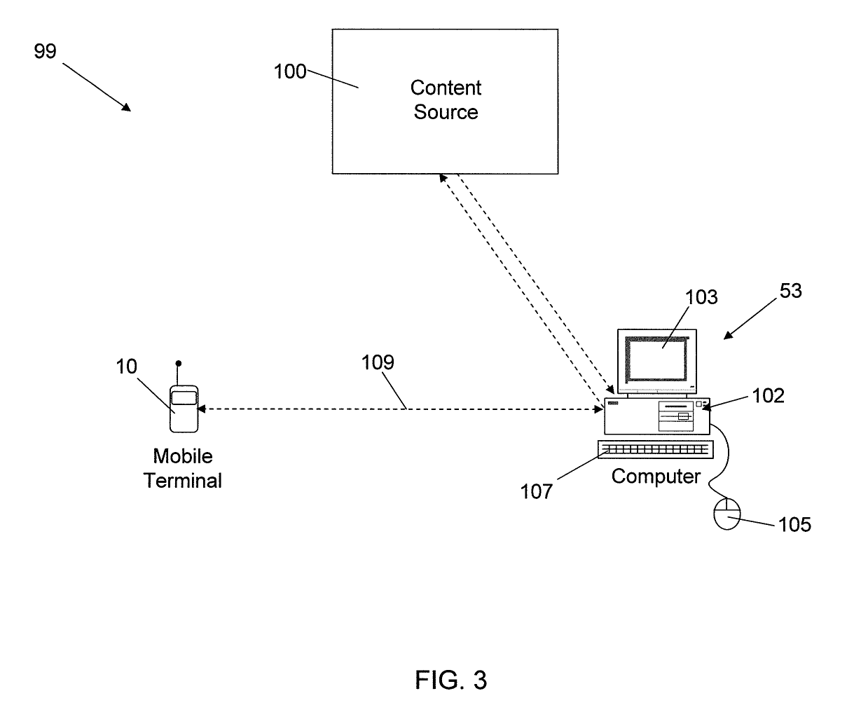

An exemplary embodiment of the invention will now be described with reference to FIG. 3, in which certain elements of a system for managing content is displayed. The system of FIG. 3 may include, for example, the mobile terminal 10 of FIG. 1 or other devices 52 depicted generally in FIG. 2. However, it should be noted that the system of FIG. 3, may also be employed with a variety of other devices, both mobile and fixed, and therefore, embodiments of the present invention should not be limited to use with devices such as the mobile terminal 10 of FIG. 1 or the devices 52 communicating via the network of FIG. 2.

In an exemplary embodiment, content or data may be communicated over the network of FIG. 2 among the device 52, such as a personal computer 53 shown in FIG. 3, the mobile terminal 10 of FIGS. 1 and 2, a content provider's server 110 shown in FIG. 2, and a service provider's server 112 shown in FIG. 2. However, it should be understood that the network of FIG. 2 need not be employed for communication, but rather FIG. 2 is merely provided for purposes of example. Furthermore, it should be understood that embodiments of the present invention may be embodied in software as described below that may be resident on the device 52 or any other network device accessible by the device 52.

Referring now to FIG. 3, a system 99 for managing content is provided. The system 99 of this exemplary embodiment includes a computer 53, a content source 100, and a mobile terminal 10. By interfacing with the computer 53, a user may select one or more content files to download from a content source 100 and store the selected content files in one or more devices, such as the computer 53 and/or the mobile terminal 10. As will be explained below, a list of the downloaded content files may be displayed by the computer 53 along with an indication of the devices configured to store the content files as well as the one or more devices in which the downloaded content files are actually stored. In this way, a visible indicia of each content file and its location (e.g., a representation of each device in which the content file is stored and/or each device in which the file is not stored) may be provided to the user.

The computer 53 includes means for communicating with the content source 100, such as a processor 102 configured to communicate with the content source 100. The content source 100 may be integral to or accessible by the content provider's server 110 (shown in FIG. 2) and may be configured to store content that may be accessed and copied, e.g., downloaded, by the various devices 52, such as the computer 53 and the mobile terminal 10. Content files stored in the content source 100 may be audio content (such as songs and music) or video content (such as movies, television broadcasts, and music videos), among other types of content. For example, the content source 100 may be a video content library storing a number of movies that may be downloaded by a user for viewing at home. As previously mentioned, the processor 102 of the computer 53 may communicate with the content source 100 via a packet-switched network, such as the Internet, or any other network including the networks of FIG. 2.

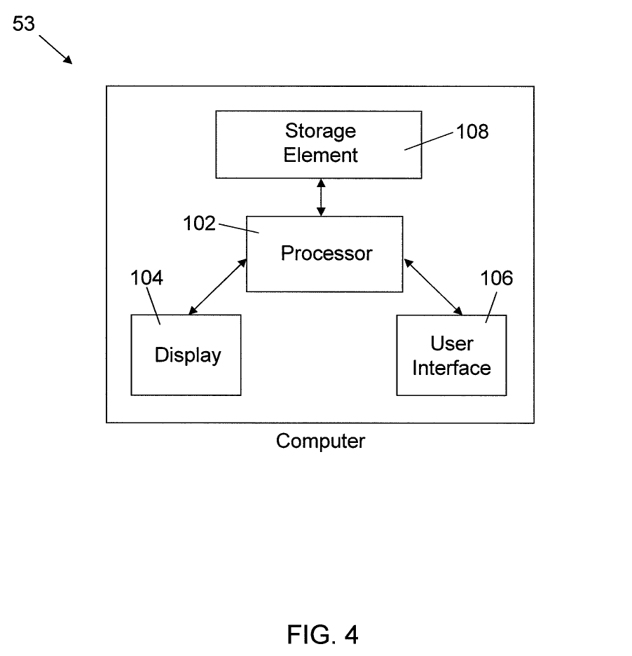

Referring to FIG. 4, the computer 53 may include a display 104, such as a computer monitor 103 (shown in FIG. 3), a television screen, or other means for displaying information provided by the processor 102. Furthermore, means for receiving user input (including, for example, the selection of a particular content file stored in the content source), such as a user interface 106, may be provided. The means may include a user input device such as a mouse 105 (shown in FIG. 3), a keyboard 107 (also shown in FIG. 3), a touch display, or any other device configured to receive an input from the user. By communicating with the display 104 and the user interface 106, the processor 102 may solicit information from the user regarding the management of content. Referring again to FIG. 3, the processor 102 may, for example, generate a display (such as a dialog box or user input window) upon the computer monitor 103 requesting input from the user or allowing the user to make selections via the user interface 106. For instance the user may use a mouse 105 to select one or more content files to download from a list of content files available on the content source 100 and represented on the computer monitor 103, and the user may also use the mouse 105 to select one or more devices (such as the mobile terminal 10 or the computer 53) in which to store the content files to be downloaded, as described below.

In this regard, the processor 102 of the computer 53, or other means, may be configured to communicate with a number of devices and to identify devices or storage elements configured to store content files, or at least configured to store the content files selected to be downloaded, and to which the computer 53 may have access to store the downloaded content files. The processor 102, or other means for storing the selected content file(s), may download each selected content file to one or more of the identified devices for storage. Furthermore, the computer 53 or other apparatus may include means, such as the processor 102, for identifying the content files stored by the devices with which it can communicate and for providing a visible indicia of each device in which each content file is stored.

For example, in the system 99 of FIG. 3, the processor 102 may identify the mobile terminal 10 as being in communication with the processor 102 and accessible to the computer 53 (illustrated by the dashed line 109). The mobile terminal 10 of this example may, for instance, be configured to communicate with the processor 102 of the computer 53 via a Bluetooth connection or may otherwise be present to the processor 102. In addition, the processor 102 may identify a storage element 108, shown in FIG. 4, as being configured to store the selected content file(s). The storage element 108 may be Random Access Memory (RAM) available on a hard drive of the computer 53, a portable storage element connected to the computer 53 (such as a Universal Serial Bus (USB) flash drive, floppy disk, Zip disk, Compact Disk (CD), or Digital Video Disc (DVD), among others), or a storage element of another device in communication with the computer 53 (such as a server or another computer).

Referring again to FIG. 3, a user may interface with the computer 53 to select a content source 100 from which to download a content file. For example, the user may visit a website associated with the content source 100 that presents a list of content files, such as movie titles, from which the user may select one or more content files to download. Content files may be accessed in various ways. For example, a connectivity engine such a browser-based application (e.g., Internet Explorer, Netscape Navigator, and Firefox, among others) may be used to access the content files. The content provider for the particular content source 100 may use a custom Uniform Resource Locator (URL) protocol identifier on the website to initiate management of the content files as described herein. For example, a content provider's website may typically provide a link to a content file using Hypertext Transfer Protocol (http) as follows: http://www.contentsourcewebsite.com/download/contentfile.mp4. However, in order to provide for management of the content as described herein, the content provider may provide the same content file through the following link: nvd://www.contentsourcewebsite.com/download/contentfile.mp4. Thus, in this example, the custom URL protocol identifier “nvd” may be used to invoke a particular software application that includes executable instructions allowing the processor 102 of the computer 53 to support the management of the selected content file(s).

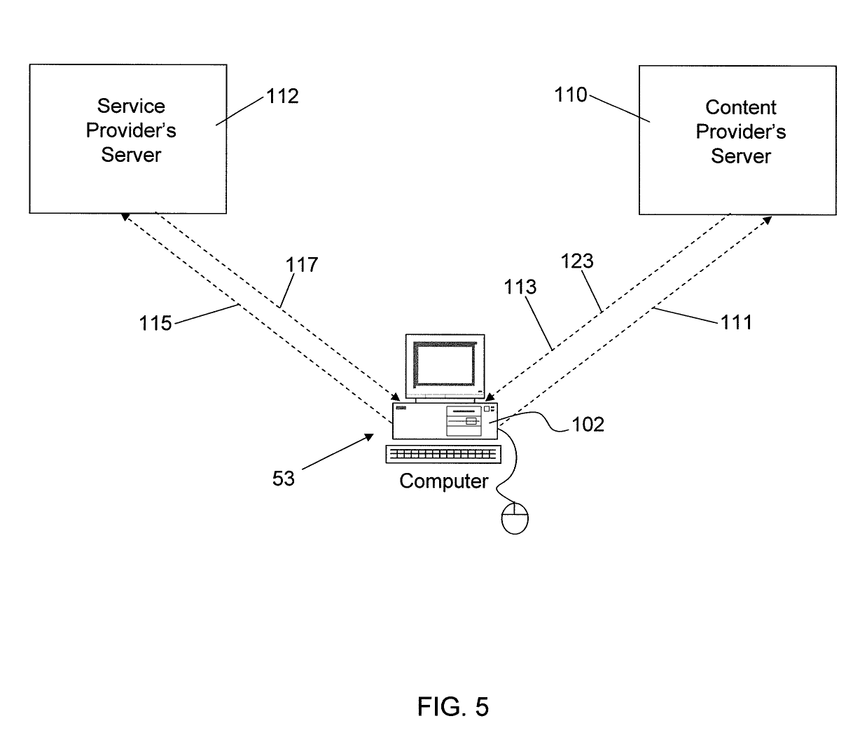

Continuing this example, a user's selection of an “nvd” content file may allow a service provider to download a software application or to insure that a software application has been previously downloaded to the computer 53 that provides instructions to the processor 102 for managing the content. For example, referring to FIG. 5, the user's selection 111 of an “nvd” content file may cause the content provider's server 110, which may manage or otherwise have access to the content source 100, to query 113 the requesting computer 53 as to whether a content management software application is installed on the computer 53. As a result, a first time user selecting an “nvd” content file may be prompted to install the content management software application from the service provider's server 112 or from some other source of the content management software application. Thus, upon the user's agreement to the installation, the computer 53 may be directed to the service provider's website or other source to download the application. A request 115 may be sent by the computer 53 to the service provider's server 112 or other source for the application, and a copy of the application may then be downloaded 117 and stored on the computer 53 (for example in the storage element 108) as instructed by the service provider's server 112 or other source of the application.

As part of the installation of the content management software application, the service provider's server 112 may transmit and store a cookie on the computer 53 containing data regarding the installation, such as where the application may be found on the computer 53. In this way, subsequent invocations of the content management software application resulting from subsequent selections of “nvd” content files may direct the content provider's server 110 to the application already stored on the computer 53 instead of prompting the user to download the application from the service provider's server 112 unnecessarily. Thus, in response to a subsequent selection of an “nvd” content file in this example, the content provider's server 110 may query 113 the requesting computer 53 regarding the installation of the content management application and may be directed by the cookie to the location on the computer 53 in which the application was stored.

Alternatively, selection of an “nvd” content file may result in a query 113 to the user asking whether the application is installed on the computer 53. For example, a dialog box may be generated by the processor 102 for display on the computer monitor 103 asking “Is the Content Management Software Application available on your computer?” The user's input of a “No” response may prompt installation of the application, as previously described, whereas the user's input of a “Yes” response may allow the content provider's server 110 to save a cookie to the computer 53 and to invoke the application for this and subsequent transactions without asking the same question.

Once the application has been installed on the computer 53, the processor 102 may execute instructions embedded in the software application to control the download process and manage the content. For example, the processor 102 executing the instructions may check to see if there is any other device connected to the network (i.e., in communication with the computer 53) which may be configured to store the selected content file(s), as previously mentioned. If such devices are detected, the user may be asked for input regarding the device to which the content file(s) should be stored. For example, referring to FIG. 3, the processor 102 of the computer 53 may detect a mobile terminal 10 capable of storing the selected content file(s). Because the user in this case would have the option of storing the downloaded files in the storage element 108 of the computer 53, in the mobile terminal 10, or in both devices, the processor 102 may query the user as to his preference.

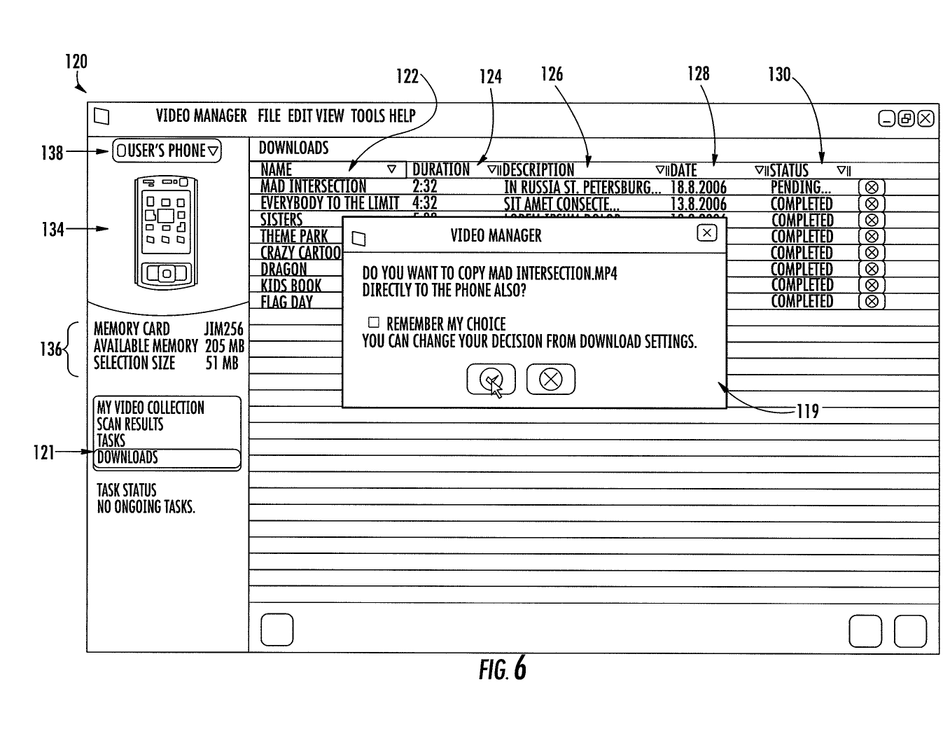

In some cases, as shown in FIG. 6, the processor 102 may generate a dialog box 119 asking whether the user wants to copy the selected content file (in this example, “Mad Intersection.mp4”) to an additional device configured to store the content, such as a phone in communication with the processor 102. The dialog box 119 may be superimposed on a screen 120 showing various information regarding the content file selected for downloading, other files that may have been downloaded, and other information regarding the system 99 and the devices.

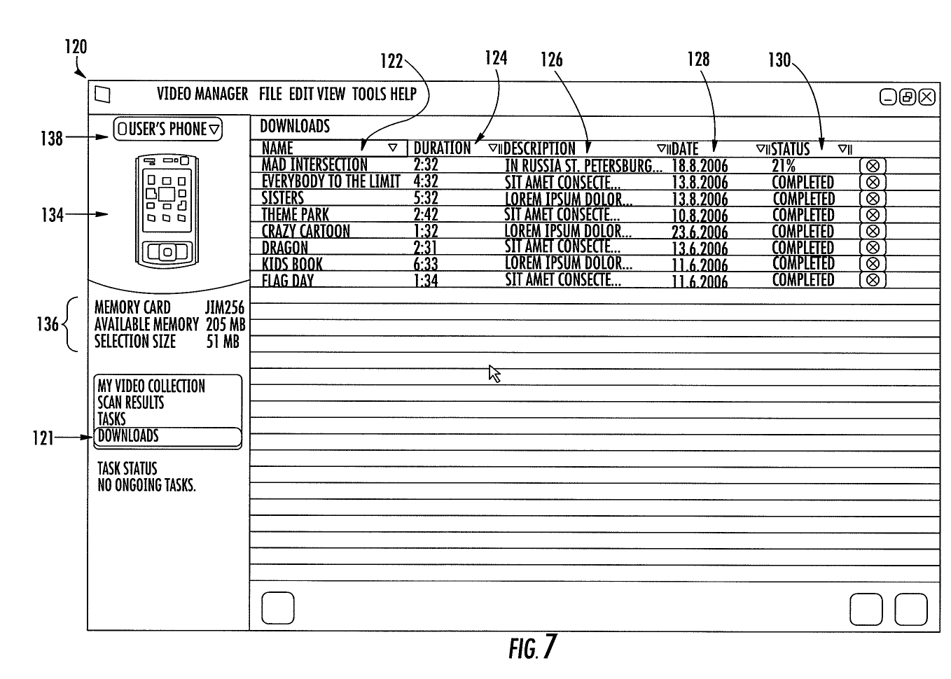

For example, the processor 102 may generate a screen 120 providing information regarding the content files selected for downloading from the content provider's website (such as the Name 122 of the content file; the Duration 124 of each file in hours, minutes, and/or seconds; a Description 126 of each file; the Date 128 the file was downloaded; and the Status 130 of the download process, among other data. The processor 102 of the computer 53 may be instructed by the content management application to display the Status 130 depicting the progress of the download process, as shown in FIGS. 6 and 7. For example, the Status 130 may include the percentage completion of the download, as shown in FIG. 7. Furthermore, other information regarding the configuration of the devices detected by the processor 102 may be displayed on the screen 120, such as the type of storage of the device, and the available memory. For example, an area 134 of the screen 120 may be used to display a graphical representation of one of the devices 53, 10 detected and the configuration data 136 for the respective device. The user may choose to view the configuration data 136 of a different device by selecting the other device from a drop down menu or other user input button 138 displayed in the area 134. In some cases, multiple devices may be displayed at the same time along with the configuration data 136 for each device.

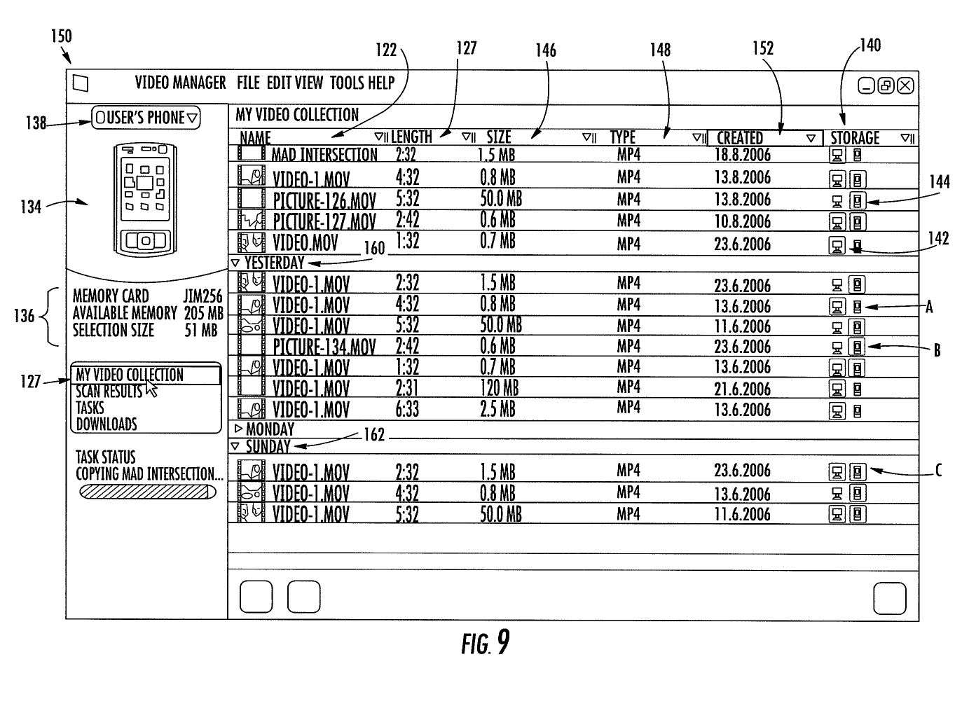

In other embodiments not shown, the devices available to store each selected file may be depicted graphically for each file, such as under a Storage category 140, similar to that shown in FIG. 9. For example, an icon 142 of a computer may be generated for each file that may be stored on the computer 53, and an icon 144 of a mobile terminal may be generated for each file that may be stored on the mobile terminal 10. In this way, the user may select the device or devices to which he wishes to download the selected files by selecting the respective icon 142, 144. Thus, a user who only wishes to store the downloaded file to his computer 53 may use his mouse 105 to select the icon 142 of a computer. A user who only wishes to store the downloaded file to his mobile terminal 10 may likewise use his mouse 105 to select the icon 144 of a mobile terminal, and a user who wishes to store the file in both devices may select both icons 142, 144. If the user has selected multiple files to download from the content provider's website, the user may choose to store some files in one device, some in the other device, and some in both devices by selecting the appropriate icon(s) 142, 144 corresponding to each selected content file.

Alternatively, the device(s) in which each content file is to be stored may be provided by a predefined storage methodology. For example, the methodology may designate the device for storage based on the type of content file downloaded, providing that certain types of files are to be stored in one device (such as the computer 53), and other types of files are to be stored in the other device (such as the mobile terminal 10). For example, the methodology may provide that music files are to be stored in the computer 53 as well as the mobile terminal 10, whereas video content files are to be stored only in the computer 53. The methodology may designate the device for storage based on characteristics of the devices, such as the amount of memory available in the storage areas of the computer 53 and/or the mobile terminal 10. Or, the methodology may designate the device for storage based on the types of devices detected. For example, if a mobile terminal 10 is detected, the methodology may provide that the content files are to be stored in the mobile terminal 10 in addition to (or instead of) being stored in the computer 53. The storage methodology may be defined by the user or by the application itself, independent of the user.

The content file(s) selected to be downloaded may be retrieved from the content provider's server in any way, according to the configuration of the content provider's server. In some cases, the user's input may be required to confirm that the user wishes to proceed with the download. Referring again to FIG. 5, in order to download the content files, the processor 102 of the computer 53 may remove the custom URL protocol identifier from the address of each content file (e.g., “nvd”) and replace it with “http,” according to instructions in the content management application, such that the computer 53 may send an HTTP Get Request 111 to the content provider's server 110. In this way, no special support or implementation is needed from the content provider, and the content provider's server 110 may handle the request in the same manner in which it handles all other requests for content files with or without content management software installed on the requesting computer 53.

Once a selected file has been downloaded 123, the processor 102 may be configured to perform file conversions on the content files, depending on the type of content file and the configuration of the device in which the file is to be stored. For example, the user may have selected a content file to be downloaded and stored to the storage element 108 of the computer 53 as well as the mobile terminal 10. Although the particular file may be originally configured by the content provider for storage and subsequent use on the computer 53, use of the same file may not be fully supported on the mobile terminal 10. For example, if the file is a video file, the user may not be able to view the whole frame on the display of the mobile terminal 10, or there may be other problems that would prevent the user from experiencing the content file on the mobile terminal 10 in the way the file was intended to be experienced. Thus, the processor 102 may convert the content file to an appropriate file type or perform other modifications or adjustments to the file to facilitate the use of the file on the mobile terminal 10 in this example prior to copying and storing the file in the mobile terminal 10. Likewise, the processor 102 may set or adjust the configurations or settings of the respective devices to which the content files are sent in order to facilitate better use of the content files by the user.

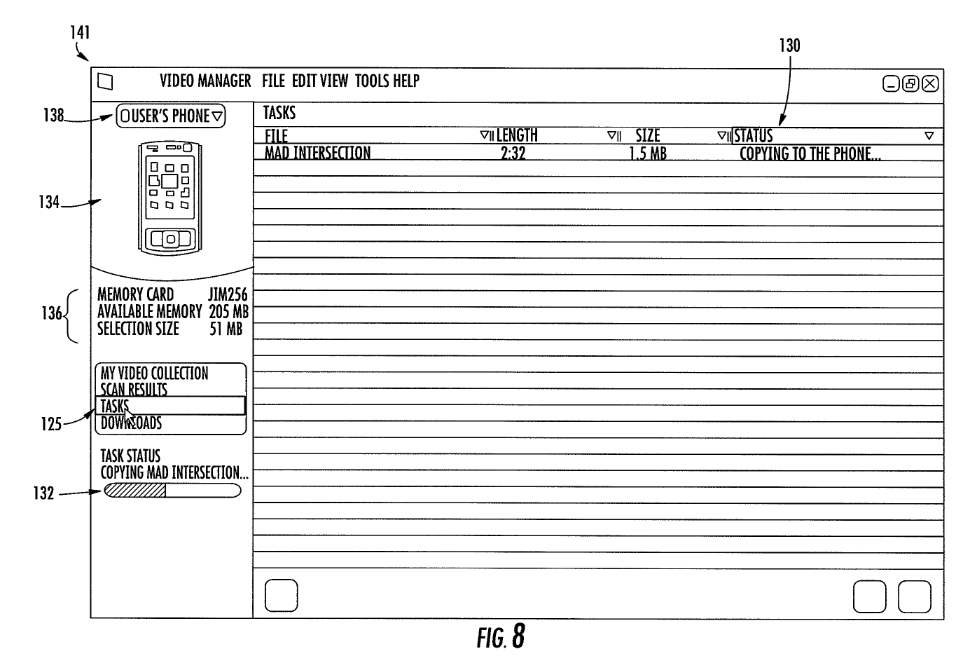

In some embodiments, the user may be able to select a tab 125 for “Tasks,” as shown in FIG. 8, to monitor the status of the storage process. For example, the “Tasks” tab may cause a screen 141 to be displayed showing the content file or files that are currently being downloaded from the content source 100 or being copied for storage to the designated device(s). The Status category 130 may, for example, indicate the current action of the processor 102 (such as “copying to the phone”). Also, the progress of the current action may be displayed graphically, such as with a bar 132 that is gradually filled in as the current action advances towards completion.

Before, during, or after the download/copy/store processes are completed, a user may be able to view the content files that have been previously downloaded using the application. The processor 102 may generate a display of the various content files that have been downloaded previously by the user including information regarding the files, the device(s) configured to store each file, and the device(s) in which each file is stored. For example, FIG. 9 shows a screen 150 that may be generated and displayed when the user selects a tab 127 for “My video collection.” Information displayed under this tab may include the Name 122, Length 127, Size 146, and Type 148 of each content file that has been previously downloaded using the content management software application, as well as the date the file was created 152, the device(s) configured to store each file, and the device(s) actually storing each file (such as under the Storage category 140). As previously mentioned, icons 142, 144 representing the devices may be included next to each content file to show the respective devices configured to store each file, with the icons representing the devices in which the respective content file is stored being highlighted or otherwise differentiated.

For example, in FIG. 9, one content file A may show only the icon 142 representing the computer 53 highlighted, another content file B may show only the icon 144 representing the mobile terminal 10 highlighted, and yet another content file C may show both icons 142, 144 highlighted, reflecting the device or devices in which the user may expect to find the particular content file. In this way, the user may view a summary of his downloaded content files and may be able to determine at a glance which files are stored in which devices. Furthermore, the files may be organized according to the date on which the files were downloaded or created. For example, a content file A downloaded yesterday may appear under a category 160 “Yesterday,” and a content file C downloaded the previous Sunday may appear under a category 162 “Sunday.” Thus, a user may be able to find a particular content file based on the Name of the file or any other characteristic (Length, Size, Type, etc.) as well as based on the date the file was downloaded.

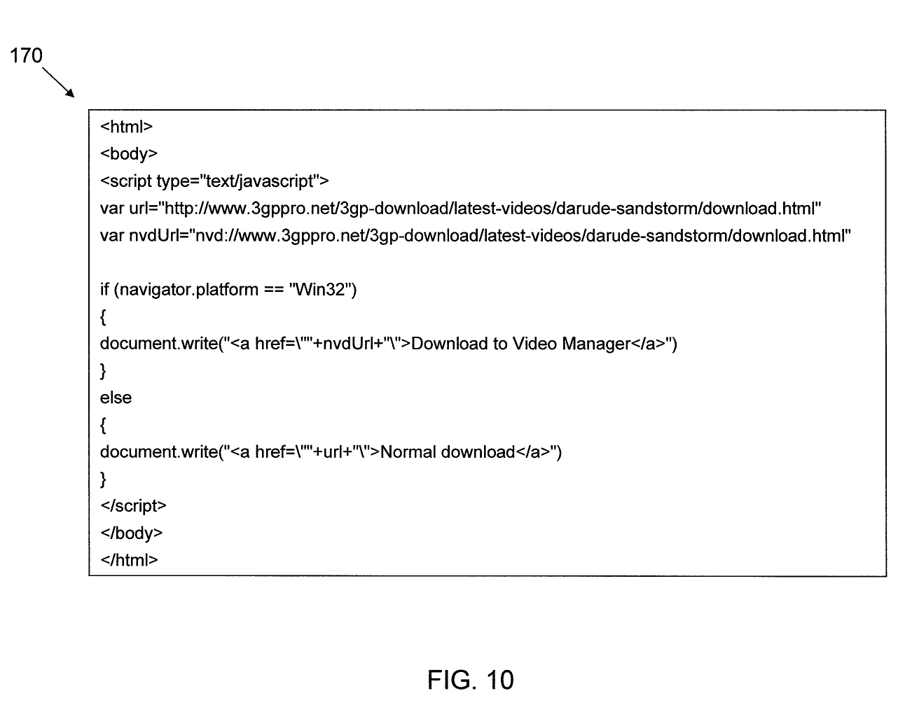

Although the examples above describe a user accessing content files through the computer 53, the user may also be able to download content files from the content provider's website using other devices, such as the mobile terminal 10. The mobile terminal 10 may be configured to support a content management software application, as described above. However, the mobile terminal 10 may still be configured to download and store content files even if the mobile terminal 10 is not configured to support the content management software application. In the case the mobile terminal 10 is not configured to support the content management software application, the content provider's website may be configured to display the link using an http identifier (as opposed to a custom URL protocol identifier) to the mobile terminal 10. For example, a javascript 170 such as the one shown in FIG. 10 may cause the link for the content file to appear to the user with a unique URL protocol identifier (e.g., “nvd”) if the user is accessing the content provider's website via the computer 53 and with an http identifier if the user is accessing the content provider's website via a mobile terminal 10 that does not support the content management application.

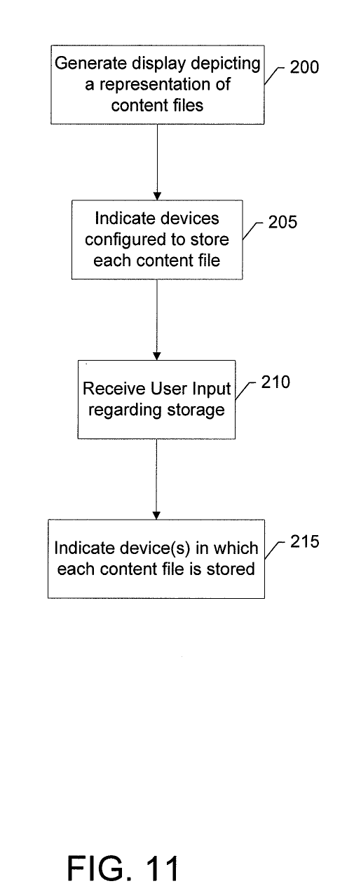

In other embodiments, a method for managing content is provided. Referring to FIG. 11, a display is generated depicting a representation of one or more content files. See FIG. 11, block 200. For example, each content file selected by a user for downloading from a content provider's website may be listed along with various characteristics of each file, such as duration, file size, and file type. The devices configured to store each content file may also be indicated, such as by detecting storage areas and other devices that are connected to a common network and are accessible for storing the selected content. Block 205. For example, the devices may be indicated using icons representing each device, as previously described.

In some embodiments, user input regarding the device or devices in which the content file(s) are to be stored may be received. Block 210. The user may, for example, be asked whether he wishes to save a particular content file to a detected device, such as the user's mobile terminal. Alternatively, the user may select one or more of the icons representing the devices detected in which to store the content file.

Once the content file is downloaded from the content provider's server, such as from a content source managed or otherwise accessible to the content provider's server, the device(s) in which each content file is stored may be indicated. Block 215. As mentioned above, icons representing the device or devices storing the content may be highlighted or otherwise differentiated from icon(s) representing devices configured to store the content but not selected by the user to actually store the content. In this way, the user may be able to view a list of the content files downloaded and receive an indication of which devices are storing which content files.

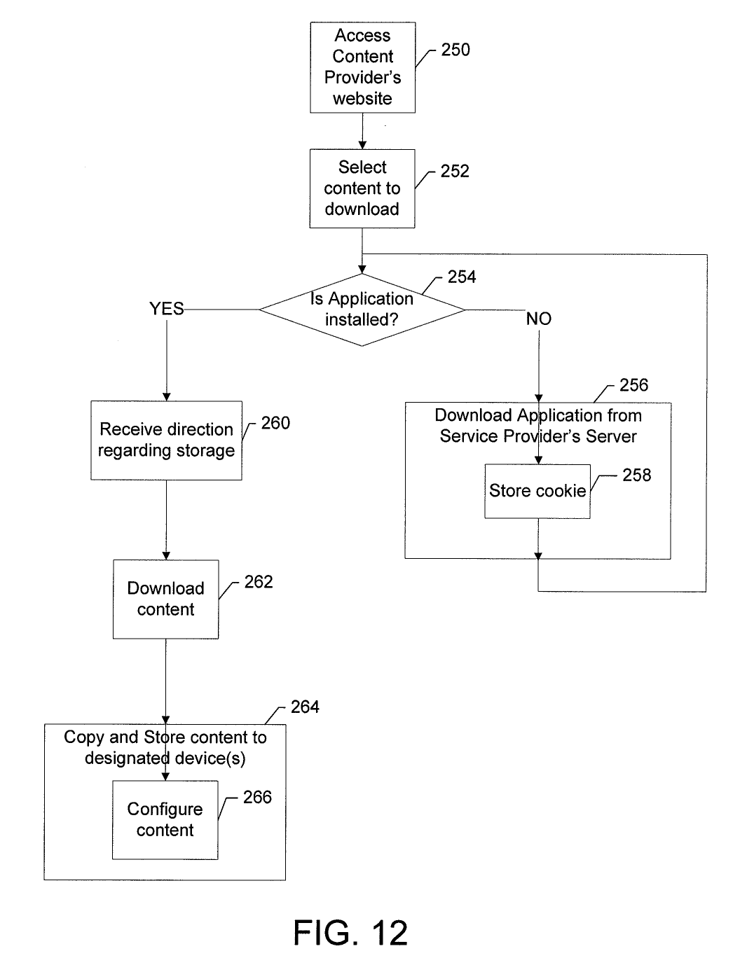

In another embodiment, shown in FIG. 12, a content provider's website is initially accessed by a user, such as a user of a computer visiting a particular content provider's website on the Internet. One or more content files listed on the website may then be selected. See FIG. 12, blocks 250, 252. As previously discussed, the links for the content files may be provided using a unique URL protocol identifier, such as “nvd.” Selecting a content file with an “nvd” identifier may then prompt an inquiry by the content provider's server as to whether a content management software application is installed on the user's computer. Block 254.

If the user is a first time user and the application is not installed, the content provider's server may direct the user's computer to access the service provider's server to download and install the application. Block 256. In the process of downloading the application, the service provider's server may also store a cookie on the user's computer so that subsequent selections of “nvd” content will not prompt the same inquiry. Block 258. Alternatively, the user may be asked whether he has the application installed on the computer, and a “yes” answer may likewise be stored as a cookie to provide for direct access of the application without similar questions in the future.

If the user already has the application installed, the user's input may be required regarding the device or devices in which he wishes to have the content files stored. Block 260. As previously mentioned, the user may wish to store the content in one or more devices, and the user's input may be received in several ways. The user may, for example, respond to a dialog box asking whether he wishes to store the particular file in a certain device, or the user may select icons corresponding to the devices in which he wishes to store the content. Alternatively, the device(s) to which the content is to be stored may be determined by a predefined storage methodology. For example, the methodology may designate the device for storage based on the type of content file downloaded, providing that certain types of files are to be stored in one device, and other types of files are to be stored in the other device. Or, the methodology may designate the device for storage based on the types of devices detected. For example, if a device in addition to the user's computer is detected, the methodology may provide that the content files are to be stored in the additional detected device as well as (or instead of) the computer. The storage methodology may be defined by the user or by the application itself, independent of the user.

The content files selected may also be downloaded. Block 262. Although shown in FIG. 12 as occurring after the user input is received, the content may be downloaded before, during, or after the user designates the devices for storage. The “nvd” identifier may be changed to an “http” identifier in order to accomplish the download without requiring the content provider's server to have special functionality. Once the content has been downloaded to the user's computer, the content file(s) may then be copied and stored to the designated devices. Block 264. Copying and/or storing the files may in some cases include configuring the content accordingly, depending on the device in which the content is to be saved. Block 266. For example, a file saved to a mobile terminal may need to be configured differently from the same file saved to a computer's storage element, depending on the configuration of the two devices and the applications installed on each device that are capable of supporting the use of the content.

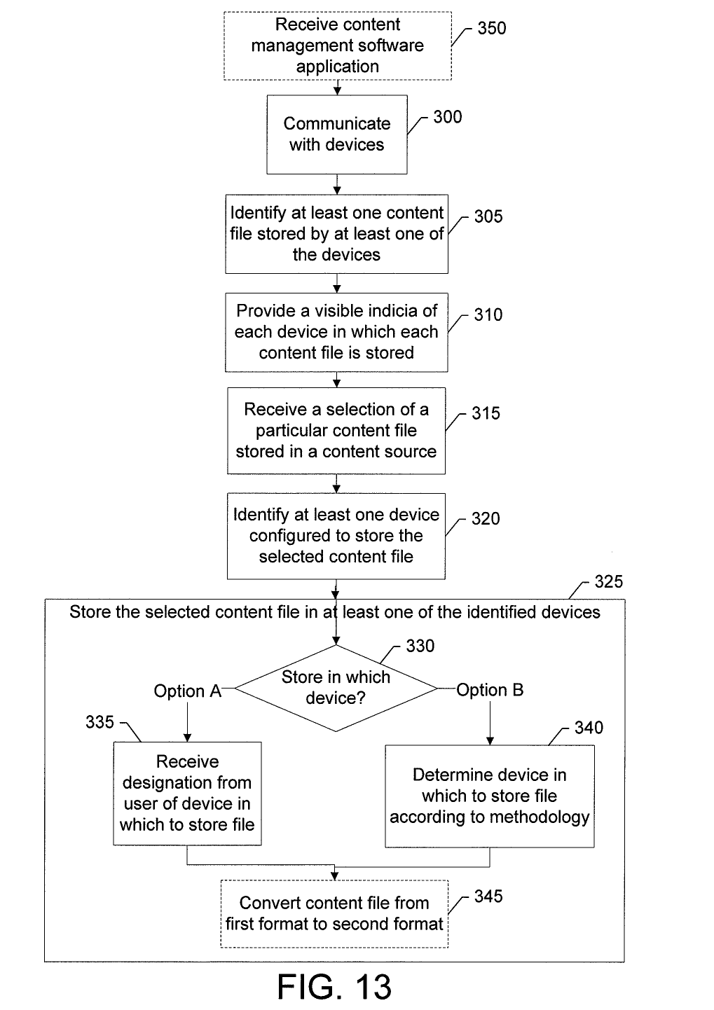

In the embodiment shown in FIG. 13, the apparatus (e.g., a computer) initially communicates with devices, such as a mobile terminal that is accessible or present to the processor of the computer. One or more content files that are stored by at least one of the devices are identified, and a visible indicia of each device in which each content file is stored is provided. See FIG. 13, blocks 300-310. In some cases, a selection of a particular content file stored in a content source is received from a user, and at least one device configured to store the selected file is identified. Blocks 315-320. The selected content file may then be stored in one or more of the identified devices. Block 325.

The device in which the content file is to be stored may be determined in various ways. For example, a designation of the device in which the file is to be stored may be received from a user. Blocks 330, 335. As another example, the device may be determined according to a methodology that considers one or more factors, such as the type of content file, the amount of memory available in the device, the type of device, and/or a user preference. Blocks 330, 340.

In some cases, the content file may be converted from a first format as received from the content source to a second format that is compatible with each device in which the selected content file is stored. Block 345. For example, the selected file may be re-sized to fit the screen of a mobile terminal that a user designates to receive the file. Furthermore, a content management software application may be received from a service provider prior to the receipt of the selected content file from the content source. Block 350. This may occur, as described above, by accessing the selected content file from the content source via a custom URL protocol identifier, such as “nvd,” that invokes the installation of the content management software application.

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer, mobile terminal, or other programmable data processing apparatus, such as the processor 102 (shown in FIG. 4) or the controller 20 (shown in FIG. 1), to function in a particular manner, such that the instructions stored in the computer-readable memory produce an article of manufacture including computer-readable instructions for implementing the function specified in the flowchart block or blocks illustrated in FIGS. 11, 12, and 13. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising a processor configured to:
communicate with a plurality of devices;
identify at least one content file stored by at least one of the devices; and
provide a visible indicia of each device in which each content file is stored.

2. The apparatus of claim 1 further comprising a display configured to communicate with the processor and to present the indicia of each device in which each content file is stored.

3. The apparatus of claim 1, wherein the processor is further configured to:
receive a selection of a particular content file stored in a content source from a user;
identify at least one device configured to store the selected content file; and
store the selected content file in at least one of the identified devices.

4. The apparatus of claim 3 further comprising a user interface configured to communicate with the processor and to receive input from the user designating at least one aspect of content management selected from the group consisting of a particular content file to be downloaded from the content source and at least one of the identified devices in which to store the particular content file.

5. The apparatus of claim 3, wherein the processor is configured to determine the at least one identified device in which to store the selected content file according to a methodology that considers a factor selected from the group consisting of a type of content file, an amount of memory available in the device, a type of the device, and a user preference.

6. The apparatus of claim 3, wherein the processor is configured to convert the selected content file from a first format as received from the content source to a second format that is compatible with each device in which the selected content file is stored.

7. The apparatus of claim 3, wherein the processor is configured to receive a content management software application from a service provider prior to receiving the selected content file from the content source by accessing the selected content file from the content source via a custom Uniform Resource Locator protocol identifier.

8. The apparatus of claim 1, wherein the processor is configured to provide an indication of at least one characteristic of each content file selected from the group consisting of a name, a length, a size, a date of downloading, and a download status of the content file.

9. A method comprising:
communicating with a plurality of devices;
identifying at least one content file stored by at least one of the devices; and
providing a visible indicia of each device in which each content file is stored.

10. The method of claim 9 further comprising:
receiving a selection of a particular content file stored in a content source from a user;
identifying at least one device configured to store the selected content file; and
storing the selected content file in at least one of the identified devices.

11. The method of claim 10, wherein storing the selected content file comprises receiving a designation from a user of at least one of the identified devices in which to store the selected content file.

12. The method of claim 10, wherein storing the selected content file comprises determining at least one of the identified devices in which to store the selected content file according to a methodology that considers a factor selected from the group consisting of a type of content file, an amount of memory available in the device, a type of the device, and a user preference.

13. The method of claim 10, wherein storing the selected content file comprises converting the selected content file from a first format as received from the content source to a second format that is compatible with each device in which the selected content file is stored.

14. The method of claim 10 further comprising receiving a content management software application from a service provider prior to receiving the selected content file from the content source by accessing the selected content file from the content source via a custom Uniform Resource Locator protocol identifier.

15. The method of claim 9 further comprising providing an indication of at least one characteristic of each content file selected from the group consisting of a name, a length, a size, a date of downloading, and a download status of the content file.

16. A computer program product comprising at least one computer-readable storage medium having computer-readable program code portions stored therein, the computer-readable program code portions comprising:
a first executable portion for communicating with a plurality of devices;
a second executable portion for identifying at least one content file stored by at least one of the devices; and
a third executable portion for providing a visible indicia of each device in which each content file is stored.

17. The computer program product of claim 16 further comprising:
a fourth executable portion for receiving a selection of a particular content file stored in a content source from a user;
a fifth executable portion for identifying at least one device configured to store the selected content file; and
a sixth executable portion for storing the selected content file in at least one of the identified devices.

18. The computer program product of claim 17, wherein the sixth executable portion is further configured for receiving a designation from a user of at least one of the identified devices in which to store the selected content file.

19. The computer program product of claim 17, wherein the sixth executable portion is further configured for determining at least one of the identified devices in which to store the selected content file according to a methodology that considers a factor selected from the group consisting of a type of content file, an amount of memory available in the device, a type of the device, and a user preference.

20. The computer program product of claim 17, wherein the sixth executable portion is further configured for converting the selected content file from a first format as received from the content source to a second format that is compatible with each device in which the selected content file is stored.

21. The computer program product of claim 17 further comprising a seventh executable portion for receiving a content management software application from a service provider prior to receiving the selected content file from the content source by accessing the selected content file from the content source via a custom Uniform Resource Locator protocol identifier.

22. The computer program product of claim 16 further comprising a fourth executable portion for providing an indication of at least one characteristic of each content file selected from the group consisting of a name, a length, a size, a date of downloading, and a download status of the content file.

23. An apparatus comprising:
means for communicating with a plurality of devices;
means for identifying at least one content file stored by at least one of the devices; and
means for providing a visible indicia of each device in which each content file is stored.

24. The apparatus of claim 23 further comprising:
means for receiving a selection of a particular content file stored in a content source from a user;
means for identifying at least one device configured to store the selected content file; and
means for storing the selected content file in at least one of the identified devices.
